(19) United States
(12) Patent Application Publication
(10) Pub. No.: US 2017/0149100 A1
(43) Pub. Date: May 25, 2017

(54) LITHIUM-ION SECONDARY BATTERY MANUFACTURING METHOD

(71) Applicant: TOYOTA JIDOSHA KABUSHIKI KAISHA, Toyota-shi, Aichi-ken (JP)

(72) Inventor: Kenta ISHII, Nisshin-shi, Aichi-ken (JP)

(73) Assignee: TOYOTA JIDOSHA KABUSHIKI KAISHA, Toyota-shi, Aichi-ken (JP)

(21) Appl. No.: 15/129,648

(22) PCT Filed: Mar. 19, 2015
(86) PCT No.: PCT/IB2015/000371

§ 371 Date: Sep. 27, 2016

(30) Foreign Application Priority Data
Mar. 28, 2014 (JP) 2014-069726

(51) Int. Cl. H01M 10/44; H01M 10/0587; H01M 10/42; H01M 4/525; H01M 4/505; H01M 4/62; H01M 4/66; H01M 4/04; H01M 4/583; H01M 4/131; H01M 4/133; H01M 2/16; H01M 2/02; H01M 2/36; H01M 10/0569; H01M 10/0563; H02J 7/00; H01M 10/0525

(52) U.S. Cl. CPC H01M 10/44; H01M 10/0525; H01M 10/0587; H01M 10/4235; H01M 4/525; H01M 4/505; H01M 4/623; H01M 4/625; H01M 4/661; H01M 4/0404; H01M 4/583; H01M 4/131; H01M 4/133; H01M 2/1653; H01M 2/021; H01M 2/024; H01M 2/361; H01M 2/362; H01M 10/0569; H01M 10/0563; H02J 7/0042; H01M 2220/10; H01M 2220/20; H01M 2220/30; H01M 2300/004; H01M 2300/002

(57) ABSTRACT

A manufacturing method includes a battery assembly fabricating step in which a positive electrode, a negative electrode, and a nonaqueous electrolyte containing an overcharge additive and difluorophosphate are provided in a battery case, a first charging step and a conditioning step. In the conditioning step, discharging to a predetermined lowest SOC and charging to a predetermined highest SOC are performed at least once. The predetermined lowest SOC and the predetermined highest SOC are values enabling a volume change rate available when a lattice volume of a crystallite of the positive electrode active material at the lowest SOC is compared with a lattice volume of a crystallite at the highest SOC to become larger than 0% and equal to or smaller than 3%, and the highest SOC is a value enabling a high potential at which a conductive film derived from the overcharge additive can be formed.

### BACKGROUND OF THE INVENTION

1. Field of the Invention

The invention relates to a lithium-ion secondary battery manufacturing method.

2. Description of Related Art

A lithium-ion secondary battery is lighter in weight and higher in energy density than a conventional battery. Thus, in recent years, the lithium-ion secondary battery is used as a so-called portable power supply for a personal computer, a portable device or the like, or as a vehicle-driving power supply. In particular, the lithium-ion secondary battery is lightweight and is capable of obtaining a high energy density. For that reason, the lithium-ion secondary battery is beginning to be preferably used as a high-output power supply for driving a motor vehicle such as an electric vehicle (EV), a hybrid vehicle (HV), a plug-in hybrid vehicle (PHV) or the like and is expected to become increasingly popular in the future.

Typically, the lithium-ion secondary battery includes a positive electrode having a positive electrode active material layer, a negative electrode having a negative electrode active material layer, and a nonaqueous electrolyte. The lithium-ion secondary battery is a battery which performs charging and discharging as lithium ions in the nonaqueous electrolyte reciprocate between the two electrodes. A supporting salt (e.g., lithium hexafluorophosphate (LiPF₆)) is contained in the nonaqueous electrolyte. Various studies for the nonaqueous electrolyte have been made for the sake of improving the battery characteristics of the lithium-ion secondary battery and securing battery safety in case of overcharge. For example, there is known a battery added with an overcharge additive (also referred to as an overcharge inhibitor) such as biphenyl (BP), cyclohexyl benzene (CHB) or the like and a resistance inhibitor (e.g., lithium difluorophosphate (LiPO₂F₂)).

When charging the lithium-ion secondary battery, lithium ions are released (desorbed) from a positive electrode active material which constitutes the positive electrode active material layer. On the contrary, when discharging the lithium-ion secondary battery, lithium ions are stored (inserted) into the positive electrode active material. Along with the storage and release (typically insertion and desorption) of the lithium ions, the positive electrode active material is repeatedly expanded and contracted at a lattice volume level of crystallites that make up the positive electrode active material. Typically, the positive electrode active material is used in the form of secondary particles formed by aggregating a large number of fine primary particles. It is known that, due to the expansion and contraction of the positive electrode active material at the lattice volume level, the secondary particles of the positive electrode active material may sometimes suffer from breaking (including cracking) generated in grain boundaries between the primary particles having a weak binding force. Points where breaking occurs (broken portions) typically do not make contact with a conductive agent and show low conductivity. Thus, the broken portions cannot form conductive paths with the negative electrode. That is to say, the broken portions cannot serve as locations for battery reactions or reactions during overcharge. For that reason, there is a possibility that the durability of the battery decreases (or the post-cycle capacity retention rate decreases) and the reliability decreases (or the gas generation amount during charging decreases). In an effort to solve this problem, PCT International Publication No. WO 2013/108396 discloses a method in which, during a conditioning step, broken portions are previously formed in secondary particles of a positive electrode active material by performing over-discharging at a high rate after first charging and a conductive film derived from an overcharge additive (e.g., biphenyl) is formed in the broken portions by subsequent overcharging, thereby suppressing formation of broken portions and formation of conductive path breakage attributable to the formation of the broken portions during the use of a battery.

In a battery which includes a nonaqueous electrolyte containing a fluorine-containing compound (e.g., LiPF₆) as a supporting salt of a lithium-ion secondary battery, it is known that the supporting salt (LiPF₆) may sometimes be hydrolyzed during a charging/discharging process, consequently generating fluorine anions (F⁻). The fluorine anions (F⁻) are negatively charged and therefore attracted toward a positive electrode upon applying a normal voltage. The fluorine anions (F⁻) react with lithium on the surface of the positive electrode (e.g., the surface of the positive electrode active material), whereby lithium fluoride (LiF) is generated and deposited on the surface of the positive electrode active material. A film composed of LiF is a non-conductive film which becomes a resistance component. It is known that the film may possibly cause an increase in internal resistance or a decrease in durability of the battery (e.g., cycle characteristics). According to the studies conducted by the inventors, it is evident that, even when broken portions are previously formed in a positive electrode active material, if a LiF film is formed in the broken portions prior to formation of the conductive film, a polymerization reaction of a compound (e.g., biphenyl) constituting the conductive film is not smoothly generated due to the existence of the LiF film. That is to say, the inventors have found that, even if a battery is charged (overcharged) to an electric potential capable of forming a conductive film, the formability of the conductive film may possibly be impaired due to the existence of the LiF film. In addition, the elution of constituent elements (typically transition metal elements, e.g., manganese elements) from the positive electrode active material is accelerated by hydrogen fluoride (HF) generated in the formation process of the LiF film (the hydrolysis process of a supporting salt). Thus, there is a possibility that an increase in internal resistance or collapse of a crystal structure of the positive electrode active material occurs.

### SUMMARY OF THE INVENTION

The invention provides a lithium-ion secondary battery manufacturing method in which a lithium-ion secondary battery capable of securing high durability and a high gas generation amount during overcharge can be manufactured with high efficiency by previously forming broken portions in a positive electrode active material and efficiently forming a suitable conductive film in the broken portions.

The inventors have found that, if a film derived from difluorophosphate (hereinafter referred to as a DFP film) is formed on a surface of a positive electrode active material, it is possible for the DFP film to inhibit formation of a LiF film and to promote formation of a conductive film. As a consequence, the inventors have made the invention.

One aspect of the invention is directed to a lithium-ion secondary battery manufacturing method for manufacturing a lithium-ion secondary battery provided with an electrode body and a nonaqueous electrolyte, the method including the following processes:

(i) a battery assembly fabricating step in which a battery assembly is fabricated by providing inside a battery case a positive electrode having a positive electrode active material, a negative electrode having a negative electrode active material, and a nonaqueous electrolyte containing an overcharge additive and difluorophosphate;

(ii) a first charging step in which a battery is fabricated by performing a first charging process with respect to the battery assembly; and

(iii) a conditioning step in which the battery subjected to the first charging step is conditioned.

In the conditioning step, discharging to a predetermined lowest SOC and charging to a predetermined highest SOC are performed at least once. In this regard, the predetermined lowest SOC and the predetermined highest SOC are values enabling a volume change rate of a lattice volume of a crystallite of the positive electrode active material when the lattice volume of the crystallite of the positive electrode active material at the lowest SOC is compared with the lattice volume of the crystallite of the positive electrode active material at the highest SOC to become larger than 0% and equal to or smaller than 3%. The highest SOC is set as an SOC value enabling a high potential at which a conductive film derived from the overcharge additive can be formed.

Difluorophosphate (e.g., LiPO₂F₂) contained in the electrolyte is decomposed when charging the battery. The decomposition product of the difluorophosphate is attached (deposited or adsorbed) to the surface of the positive electrode active material. This makes it possible to form a film derived from the difluorophosphate (or a film containing difluorophosphate ions). The DFP film is formed prior to formation of the LiF film. Elution of transition metal elements from the positive electrode active material can be suppressed by the DFP film.

Difluorophosphate ions (PO₂F₂⁻) are repelled by negatively-charged fluorine ions (F⁻), thereby inhibiting formation of the LiF film on a film containing difluorophosphate ions (PO₂F₂⁻) (e.g., a film substantially composed of difluorophosphate ions). On the other hand, the negatively-charged difluorophosphate ions (PO₂F₂⁻) and the positively-charged overcharge additive (e.g., biphenyl) are in a mutually attracting relationship. Therefore, a conductive film derived from the overcharge additive (typically an aromatic compound) can be suitably formed on the film containing difluorophosphate ions (PO₂F₂⁻). That is to say, the formation of the DFP film makes it possible to suppress formation of a LiF film and to efficiently form a suitable conductive film derived from biphenyl. In other words, the use of the nonaqueous electrolyte containing difluorophosphate and an overcharge additive makes it possible to efficiently form a high-quality conductive film on the surface of the positive electrode active material (typically broken portions of secondary particles). A technology of adding difluorophosphate to a nonaqueous electrolyte (see Japanese Patent Application Publication No. 2013-069580 (JP 2013-069580 A)) and a technology of adding both difluorophosphate and an overcharge additive to a nonaqueous electrolyte (see PCT International Publication No. WO 2013/108396, Japanese Patent Application Publication No. 2013-211225 (JP 2013-211225 A) or Japanese Patent Application Publication No. 2013-145762 (JP 2013-145762 A)) are known in the art. However, the knowledge on the contribution of difluorophosphate to the promotion of formation of a conductive film does not exist. Accordingly, the patentability of the invention shall not be negated by these patent documents.

By performing the conditioning step under the aforementioned conditions, broken portions are formed on the surface of the positive electrode active material (typically the surfaces of secondary particles). In this case, by adding difluorophosphate to the nonaqueous electrolyte, a DFP film can be formed in the broken portions prior to formation of a LiF film. If the highest SOC in the charging/discharging process of the conditioning step is set as above, a polymerization reaction of an overcharge additive can occur on the surface of the positive electrode. This makes it possible to form a conductive film in the broken portions. That is to say, by performing the conditioning step under the aforementioned conditions, it is possible to form a DFP film on the surfaces of the broken portions of the positive electrode active material and to form a conductive film on the surface of the DFP film.

By forming the broken portions on the surface of the positive electrode active material, forming the DFP film in the broken portions and then forming the conductive film on the surface of the DFP film, it is possible to significantly suppress the disconnection of conductive paths which is attributable to the broken portions and which may be generated on the surface of the positive electrode active material during the use of a battery (during the repeated charging and discharging).

According to the invention, the formation of the broken portions of the positive electrode active material and the formation of the conductive film can be realized by the conditioning step in which charging and discharging are repeated in an SOC range narrower than that of the technology disclosed in, e.g., the PCT International Publication No. WO 2013/108396. This makes it possible to significantly reduce the energy, time and cost required in battery production and to significantly improve the production efficiency. It is also possible to alleviate stresses applied to the battery due to the repetition of over-discharging and overcharging.

That is to say, as described above, according to the invention, a lithium-ion secondary battery capable of realizing the securement of high durability and the securement of an overcharge-time gas generation amount at a high level can be manufactured in an easier manner.

Biphenyl and one or more kind of aromatic compound other than biphenyl may be used as the overcharge additive. A compound having an oxidation potential (vs. Li/Li⁺) higher than an oxidation potential (vs. Li/Li⁺) of the biphenyl may be used as the aromatic compound. A film derived from biphenyl is easy to form a six-membered ring network and can take a structure similar to a crystallite skeleton of graphite. Thus, if biphenyl is added to the nonaqueous electrolyte, it is possible to form a suitable conductive film in the broken portions of the positive electrode. If the compound having an oxidation potential (vs. Li/Li⁺) higher than an oxidation potential (vs. Li/Li⁺) of the biphenyl is used in addition to the biphenyl, the biphenyl is preferentially consumed when forming the conductive film at the conditioning step. Thus, the conductive film substantially derived from the biphenyl is formed. On the other hand, the compound other than biphenyl (the overcharge additive having a high oxidation potential) which is not substantially used in the formation of the conductive film may be contained in the nonaqueous electrolyte of the battery subjected to the conditioning step, not being oxidized or decomposed. As a result, the functions (suppression of the battery potential increase, the gas generation, etc.) of the overcharge additive (the overcharge additive having a high oxidation potential) can be demonstrated during the time of overcharge. Consequently, according to the battery manufactured by the aforementioned manufacturing method, the superior cycle characteristics and the high reliability can be made compatible at a high level.

The nonaqueous electrolyte may include a nonaqueous electrolyte in which a total content of the overcharge additive based on 100 mass % of the nonaqueous electrolyte is 4 mass % or more and 5 mass % or less and in which a content of the biphenyl based on 100 mass % of the nonaqueous electrolyte is 0.5 mass % or more and 1.0 mass % or less. By using the nonaqueous electrolyte in which the total content of the overcharge additives (the total sum of the content of biphenyl and the content of the overcharge additive other than biphenyl) falls within the above range, it is possible to manufacture a battery in which an increase of an internal resistance and a decrease of battery performance (e.g., a decrease of an initial capacity) attributable to an excessive amount of overcharge additive are highly suppressed while sufficiently demonstrating the functions (the gas generation, etc.) of the overcharge additive during the time of overcharge. In addition, by using the nonaqueous electrolyte in which the content of biphenyl falls within the above range, it is possible to form a sufficient amount of conductive film on the surface of the positive electrode active material (typically the broken portions of secondary particles).

By performing the first charging step and the conditioning step, a film (or a DFP film) derived from the difluorophosphate may be formed on a surface of the positive electrode active material such that a film amount per unit surface area (1 m²) of the positive electrode active material on a molar basis of the difluorophosphate becomes 1.5 μmol or more and 4.0 μmol or less. If the film amount of the film formed on the positive electrode active material and derived from the difluorophosphate (typically the film containing difluorophosphate) is too small, it is impossible to inhibit formation of a LiF film. For that reason, there is a possibility that the formability of the conductive film is reduced. If the DFP film having the above film amount is formed on the surface of the positive electrode active material, it is possible to efficiently form the conductive film. The film amount of the DFP film large enough to cover the surface of the positive electrode active material (which includes the broken portions formed in the conditioning step) varies depending on the kind and shape of the positive electrode active material (the particle diameter of primary particles, the particle diameter of secondary particles, the amount of a binder, etc.). From the viewpoint of formability of the conductive film, if the film amount is about 4.0 μmol per unit surface area (1 m²) of the positive electrode active material, it is possible to efficiently form the conductive film. Accordingly, by forming the DFP film in the film amount which falls within the above range, it is possible to manufacture a battery having superior cycle characteristics and high reliability.

The positive electrode active material may include a positive electrode active material in which the volume change rate of the lattice volume of the crystallite when the lattice volume of the crystallite at an SOC of 80% is compared with a lattice volume of a crystallite at an SOC of 110% is larger than 0% and equal to or smaller than 3%. The use of the positive electrode active material having the aforementioned lattice volume change rate is effective in forming the broken portions on the surface of the positive electrode active material (typically the surfaces of secondary particles) at the conditioning step. Use of the positive electrode active material having a volume change rate much larger than 3% is not preferred because there is a possibility that the surface area of the broken portions capable of being formed at the conditioning step becomes larger than the film amount of the conductive film capable of being formed at the conditioning step.

A second aspect of the invention is directed to a lithium-ion secondary battery manufactured by the manufacturing method of the first aspect. The positive electrode active material includes broken portions. A film (or a DFP film) derived from difluorophosphate and a conductive film derived from an overcharge additive, are formed in the broken portions of the positive electrode active material. According to the lithium-ion secondary battery configured as above, the superior durability (e.g., the superior cycle characteristics) and the high reliability (e.g., the high safety) can be made compatible.

A rated capacity may be 35 Ah or more and a volume energy density may be 400 Wh/L or less. By setting the volume energy density at 400 Wh/L or less as mentioned above, even when there is a situation in which the battery temperature (or the electrode temperature) may be increased due to, e.g., an internal short-circuit or other causes, it is possible to make sure that the balance between the temperature increase and the temperature decrease caused by heat dissipation falls within a suitable range. By employing the above configuration, it is possible to provide a battery which is high in capacity and safety.

### BRIEF DESCRIPTION OF THE DRAWINGS

Features, advantages, and technical and industrial significance of exemplary embodiments of the invention will be described below with reference to the accompanying drawings, in which like numerals represent like elements, and wherein:

FIG. 1 is a partial sectional view schematically showing a lithium-ion secondary battery according to one embodiment of the invention.

FIG. 2 is an electron microscope (SEM) photograph illustrating the shape of secondary particles of a positive electrode active material prior to a conditioning step.

FIG. 3 is an electron microscope (SEM) photograph illustrating the shape of the secondary particles of the positive electrode active material after the conditioning step.

FIGS. 4A and 4B show manufacturing conditions and characteristics of lithium-ion secondary batteries in examples of the invention.

### DETAILED DESCRIPTION OF EMBODIMENTS

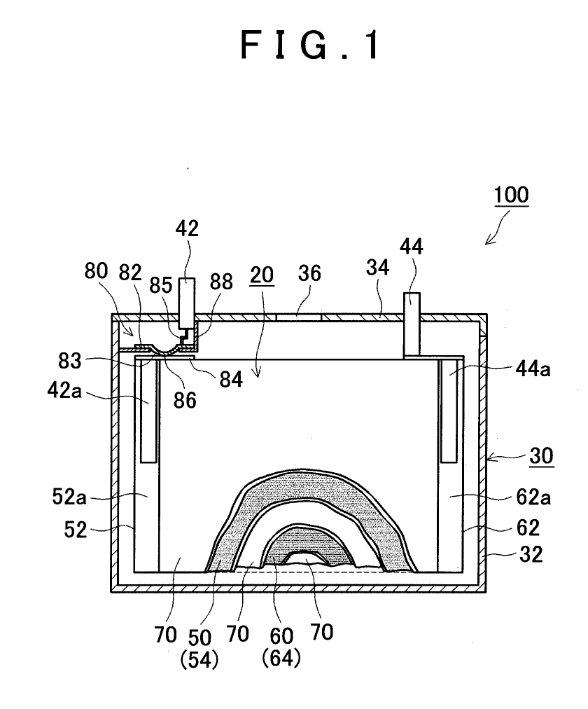

Preferred embodiments of the invention will now be suitably described with reference to the accompanying drawings. Matters necessary for carrying out the invention other than those specifically referred to in the subject specification (for example, a general manufacturing process of a battery which does not characterize the invention) may be understood as design matters of an ordinary person skilled in the related art. The invention may be carried out on the basis of the content disclosed herein and the common technical knowledge in this field. In the drawings described below, members or parts performing the same actions will be designated by like reference signs. There may be a case where duplicate description is omitted or simplified. The dimensional relationship (length, width, thickness, etc.) in FIG. 1 does not necessarily reflect an actual dimensional relationship.

The term “lithium-ion secondary battery” used herein refers to a secondary battery which uses lithium ions as electrolyte ions (a supporting salt or a supporting electrolyte) and which is charged and discharged by the movement of charges associated with the movement of lithium ions between a positive electrode and a negative electrode. The term “active material” used herein refers to a material capable of reversibly storing and releasing (typically inserting and desorbing) chemical species as charge carriers in a secondary battery.

Unless specifically mentioned otherwise, the term “SOC” (State of Charge) used herein refers to a state of charge of a battery based on a voltage range over which a battery is ordinarily used. For example, the SOC refers to a state of charge based on a rated capacity which is measured under a condition in which an inter-terminal voltage (an open circuit voltage (OCV)) ranges from 4.1 V (an upper limit voltage) to 3.0 V (a lower limit voltage). The term “1C” used herein means a current value which can charge a battery capacity (Ah) predicted from a theoretical capacity for one hour. For example, if a battery capacity is 24 Ah, the 1C is equal to 24 Ah. Alternatively, the SOC may be obtained by a current value which can discharge a battery of a fully charged state (an SOC of 100%) to a discharge terminating voltage (an SOC of 0%) for one hour.

Broadly speaking, a lithium-ion secondary battery 100 shown in FIG. 1 includes a flat wound electrode body 20, a nonaqueous electrolyte (not shown) and a flat square battery case (i.e., an exterior container) 30 which contains the wound electrode body 20 and the nonaqueous electrolyte. The battery case 30 includes a box-shaped (closed-bottom rectangular-parallelepiped) case body 32 having an opening at one end (an upper end when the battery is ordinarily used) and a lid 34 configured to close the opening of the case body 32. As shown in FIG. 1, in the lid 34, there are installed positive and negative electrode terminals 42 and 44 to be connected to the outside, a thin safety valve 36 configured to release an internal pressure of the battery case 30 when the internal pressure becomes equal to or higher than a predetermined level (e.g., a preset valve opening pressure of about 0.3 MPa to 1.0 MPa), and a pouring port (not shown) for pouring the nonaqueous electrolyte.

As shown in FIG. 1, a current interrupt mechanism (CID) 80 operated by an increase in the internal pressure of the battery case 30 is installed in the battery case 30. The current interrupt mechanism 80 may be configured to, when the internal pressure of the battery case 30 rises, cut off a conductive path extending from at least one of the electrode terminals (the positive electrode terminal 42 in this example) to the electrode body 20. Well-known different kinds of current interrupt mechanisms may be employed as the current interrupt mechanism 80. In the present embodiment, the current interrupt mechanism 80 is installed between the positive electrode terminal 42 fixed to the lid 34 and the electrode body 20. More specifically, the current interrupt mechanism 80 includes an insulation case 88 made of plastic or the like, a deformable metal plate 82 and a connection metal plate 84, latter two of which are electrically connected to each other at a junction point 86. The insulation case 88 may be installed so as to surround the deformable metal plate 82. The insulation case 88 hermetically seals the upper surface side of the deformable metal plate 82. The hermetically-sealed upper surface side of the deformable metal plate 82 is not affected by the internal pressure of the battery case 30. The central portion of the deformable metal plate 82 constitutes a curved portion 83 curved toward the lower side of the battery case 30. The peripheral portion of the curved portion 83 is connected to the lower surface of the positive electrode terminal 42 via a collector lead terminal 85. On the other hand, a positive electrode collector plate 42a is joined to the lower surface (rear surface) of the connection metal plate 84. If the internal pressure of the battery case 30 increases beyond a predetermined pressure, the downwardly-protruding curved portion 83 of the deformable metal plate 82 is deformed (vertically inverted) so as to protrude upward. Thus, the junction point 86 between the deformable metal plate 82 and the connection metal plate 84 is disconnected and the deformable metal plate 82 is moved away from the connection metal plate 84, thereby cutting off the conductive path. It goes without saying that, when embodying the invention, the structure of the current interrupt mechanism (CID) is not limited to the aforementioned embodiment.

As the material of the battery case 30, it is preferable to use, e.g., a metallic material which is lightweight and high in heat conductivity. Examples of the metallic material include aluminum, stainless steel and nickel-plated steel. The battery case 30 (the case body 32 and the lid 34) according to the present embodiment is made of aluminum or alloy mainly composed of aluminum.

As shown in FIG. 1, the wound electrode body 20 includes an elongated sheet-like positive electrode (positive electrode sheet) 50, an elongated sheet-like negative electrode (negative electrode sheet) 60, and two separators (separator sheets) 70 interposed between the positive electrode sheet 50 and the negative electrode sheet 60. The wound electrode body 20 is formed by winding the positive electrode sheet 50, the negative electrode sheet 60 and the separators 70 in a longitudinally laminated state. The positive electrode sheet 50 includes a positive electrode collector 52 and a positive electrode active material layer 54 formed on one surface or both surfaces of the positive electrode collector 52 (on both surfaces of the positive electrode collector 52 in this example). The negative electrode sheet 60 includes a negative electrode collector 62 and a negative electrode active material layer 64 formed on one surface or both surfaces of the negative electrode collector 62 (on both surfaces of the negative electrode collector 62 in this example).

As shown in FIG. 1, during the laminating process, the positive electrode sheet 50 and the negative electrode sheet 60 are superimposed and offset from each other in a width direction such that a portion of a positive electrode active material layer non-forming region 52a (namely a region where the positive electrode active material layer 54 is not formed and the positive electrode collector 52 is exposed) of the positive electrode sheet 50 protrudes in one end portion (the left end portion in FIG. 1) of the wound electrode body 20 and such that a portion of a negative electrode active material layer non-forming region 62a (namely a region where the negative electrode active material layer 64 is not formed and the negative electrode collector 62 is exposed) of the negative electrode sheet 60 protrudes in the other end portion (the right end portion in FIG. 1) of the wound electrode body 20. As a result, a laminated portion obtained by laminating and winding the positive electrode sheet 50, the negative electrode sheet 60 and the separators 70 is formed in the central portion of the wound electrode body 20. The positive electrode active material layer non-forming region 52a and the negative electrode active material layer non-forming region 62a partially overhung from the laminated portion toward the outside are formed at opposite ends of the wound electrode body 20 in the winding-axis-direction. As shown in FIG. 1, a positive electrode collector plate 42a and a negative electrode collector plate 44a are respectively joined to the positive electrode active material layer non-forming region 52a and the negative electrode active material layer non-forming region 62a by ultrasonic welding or resistance welding. As shown in FIG. 1, the positive electrode collector plate 42a and the negative electrode collector plate 44a are electrically connected to the positive electrode terminal 42 and the negative electrode terminal 44, respectively.

Next, the respective members that make up the wound electrode body 20 according to the present embodiment will be briefly described. Except the members specifically defined herein, it is possible to use the same members as those of the electrode body of the lithium-ion secondary battery of the related art.

The positive electrode 50 includes the positive electrode collector 52 and the positive electrode active material layer 54 which is formed on the positive electrode collector 52 and which contains at least a positive electrode active material. In the battery subjected to the conditioning to be described later, the positive electrode active material includes broken portions. A film derived from difluorophosphate (typically a film which contains difluorophosphate anions (PO₂F₂⁻)) is formed on the surface of the positive electrode active material (including the broken portions). Moreover, a conductive film is formed on the surface of the film derived from difluorophosphate.

As the positive electrode collector 52 that makes up the positive electrode 50, it may be possible to suitably use a conductive member made of metal superior in conductivity (e.g., aluminum, nickel, titanium, stainless steel, or the like). As the positive electrode active material contained in the positive electrode active material layer 54, it may be possible to use, e.g., a lithium composite metal oxide having a layered structure or a spinel structure (e.g., LiNi_{1/3}Co_{1/3}Mn_{1/3}O₂, LiNiO₂, LiCoO₂, LiFeO₂, LiMn₂O₄, LiNi_{0.5}Mn_{1.5}O₄, LiFePO₄, or the like).

As the positive electrode active material, it may be possible to suitably use a positive electrode active material in which, when a lattice volume of a crystallite at a SOC of 80% and a lattice volume of a crystallite at a SOC of 110% are compared with each other, a change rate of the lattice volumes is higher than 0% (typically 0.1% or higher, e.g., 0.5% or higher) and equal to or lower than 3% (typically 2.5% or lower, e.g., 2% or lower). “The lattice volume of the crystallite of the positive electrode active material” can be measured by a well-known method used in analyzing a crystal structure. For example, “the lattice volume of the crystallite of the positive electrode active material” can be measured by the following X-ray crystal diffraction method. First, a positive electrode is taken out by dismantling a battery charged up to an arbitrary charge state (e.g., an SOC of 80% or an SOC of 110%). The positive electrode is immersed in a suitable solvent (e.g., a nonaqueous solvent which makes up a nonaqueous electrolyte, specifically ethyl methyl carbonate (EMC) or the like). Then, a diffraction peak (X-ray diffraction data) is measured by irradiating CuKα rays on the positive electrode (positive electrode active material layer). The lattice volumes of the positive electrode active material in the respective charge states can be calculated based on a lattice constant obtained from the X-ray diffraction data. More specifically, when a lattice volume of a positive electrode active material used in an example to be described later is measured by the X-ray crystal diffraction method, an a-axis length and a c-axis length can be calculated from diffraction peaks (X-ray diffraction data) of a 003 plane and a 101 plane. In addition, for example, a changed amount of lattice volumes available when a lattice volume at an SOC of 0% is compared with a lattice volume at an arbitrary charge state may be used as a volume change rate.

As the positive electrode active material, it may be possible to use a positive electrode active material in the form of secondary particles formed by aggregating a large number of primary particles of about 20 nm or more and 300 nm or less which include a lithium composite metal oxide described above. The positive electrode active material in the form of secondary particles can be produced (obtained) by a well-known method (calcining, etc.). The attributes of the secondary particles of the positive electrode active material is not particularly limited. For example, the secondary particles of the positive electrode active material may be particulate or powder. The average particle diameter of the particulate secondary particles of the positive electrode active material may be 1 μm or more (e.g., 5 μm or more) and 20 μm or less (e.g., 15 μm or less). Furthermore, the specific surface area (BET specific surface area) of the particulate secondary particles of the positive electrode active material may be 0.1 m²/g or more (typically 0.7 m²/g or more, e.g., 0.8 m²/g or more) and 5 m²/g or less (typically 1.3 m²/g or less, e.g., 1.2 m²/g or less). In this regard, the average particle diameter of the positive electrode active material (the secondary particles) refers to a particle diameter (D₅₀ particle diameter or a median diameter) corresponding to 50% of accumulation counted from the fine particle side in the volume-based particle size distribution measured by particle size distribution measurement using a typical laser diffraction-light scattering method.

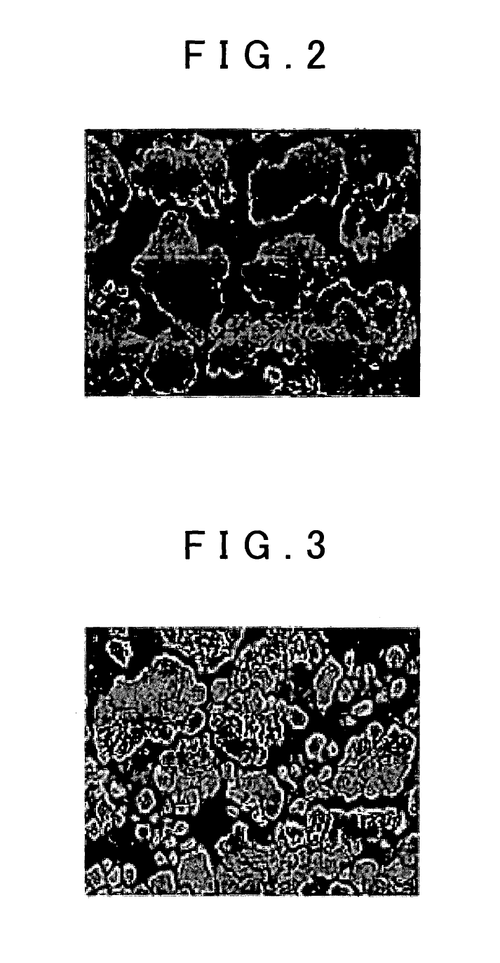

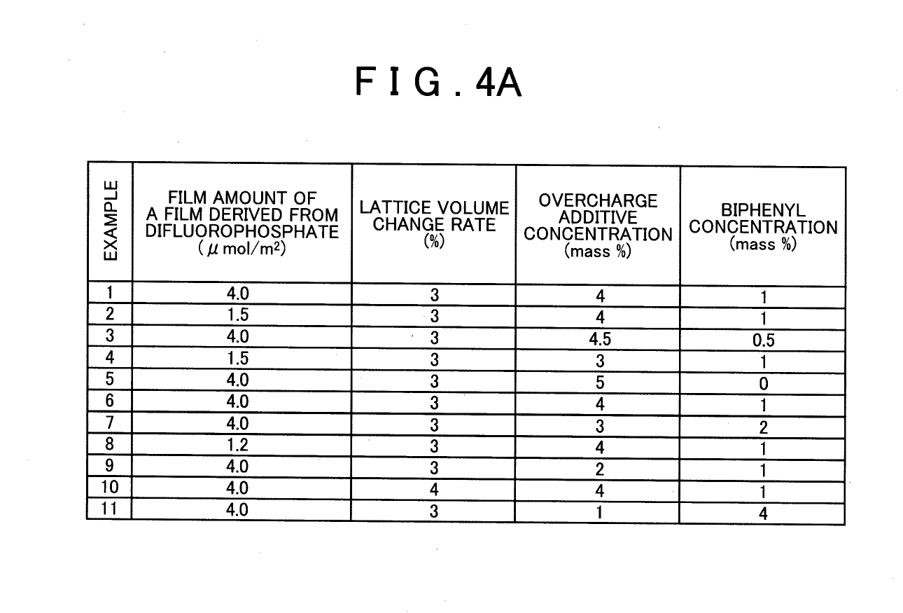

The positive electrode active material making up the positive electrode 50 (the positive electrode active material layer 54) and having the form of secondary particles includes broken portions formed in one step (a below-described conditioning step) of a battery production process (see FIGS. 2 and 3). Typically, the broken portions may exist in crystal grain boundaries having a weak binding force, among crystal grain boundaries between the primary particles which make up the secondary particles. The gap (width) of the broken portions varies depending on the shape of the primary particles and the secondary particles and the conditions of the conditioning step. Therefore, the gap (width) of the broken portions cannot be defined categorically but may be about 50 nm or more and 500 nm or less. The broken portions and the gap (width) of the broken portions can be identified (or measured) by observing the positive electrode active material with, e.g., an electron microscope (typically an SEM).

A film (DFP film) derived from difluorophosphate is formed on the surface of the positive electrode active material. The film typically contains difluorophosphate anions (PO₂F₂⁻). By forming the film, the approach of fluorine ions (F⁻) toward the positive electrode can be suitably suppressed through the use of electrostatic interaction and/or steric hindrance. It is therefore possible to suppress the generation of lithium fluoride (LiF) having a high resistance against the surface of the positive electrode active material and to suppress the inhibition of formation of a conductive film or the increase of a positive electrode resistance attributable to the formation of an LiF film on the surface of the positive electrode.

A suitable coating amount of the DFP film formed on the positive electrode active material is 1.5 μmol or more (preferably 1.8 μmol or more and more preferably 2.0 μmol or more) and 4 μmol or less (preferably 3.5 μmol or less and more preferably 3.0 μmol or less) per unit surface area (1 m²) of the positive electrode active material on a molar basis of difluorophosphate (namely on a basis of PO₂F₂⁻). In this regard, “the coating amount per unit surface area (1 m²) of the positive electrode active material” can be measured by extracting PO₂F₂⁻ from the positive electrode active material by ion chromatography (IC) and dividing the extraction amount of PO₂F₂⁻ by the active material amount in the positive electrode active material layer×the BET specific surface area (m²/g). The BET specific surface area (m²/g) can be found by analyzing, through a BET method (or a single point BET method), the gas adsorption amount measured by a gas adsorption method using a nitrogen (N₂) gas as an adsorption layer. More specifically, a positive electrode active material layer taken out by dismantling a battery is first immersed in a suitable solvent (e.g., a nonaqueous solvent which makes up a nonaqueous electrolyte, specifically EMC or the like). Thereafter, a measurement sample (or a positive electrode active material layer) is cut into an appropriate size and is collected. Then, the measurement sample is immersed in a solvent capable of eluting a measurement target film component from the measurement sample, for a predetermined time (e.g., about 1 minute to 30 minutes), whereby a measurement target film component (PO₂F₂⁻) is extracted into the solvent. An extraction solution into which the film component is extracted is subjected to IC measurement. The content (μmol) of measurement target ions (PO₂F₂⁻) can be quantified from the result thus obtained.

While the IC-using method is illustrated as a method for measuring a film amount, the invention is not limited thereto. The film amount can be roughly obtained by, e.g., an Inductively Coupled Plasma-Atomic Emission Spectrometry (ICP-AES), an X-ray Absorption Fine Structure (XAFS) or a Mass Spectrometry (MS). By virtue of this analysis, it is possible to confirm the existence of a LiPO₂F₂-derived P element which is distinguished from a P element derived from a supporting salt existing in a nonaqueous electrolyte.

If the film amount of the DFP film per unit surface area is set to become 1.5 μmol/m² or more, it is possible to realize the inhibition of formation of the LiF film and the promotion of formation of the conductive film at a higher level. That is to say, the formation of the LiF film on the surface of the positive electrode active material can be suppressed at a higher level and the conductive film can be efficiently formed on the surface of the DFP film. An excessive film amount may become a cause of increasing a battery resistance and therefore is not desirable. From the viewpoint of promoting the formation of a suitable conductive film, the film amount of the DFP film that covers the surface of the positive electrode active material may be set to become about 4 μmol/m² or less.

A conductive film is additionally formed on the surface of the positive electrode active material (typically the surface of the DFP film). This conductive film is a film substantially derived from an overcharge additive (typically biphenyl) contained in the nonaqueous electrolyte. The conductive film typically includes a compound having a benzene ring (a so-called aromatic compound). The electric conductivity of the positive electrode active material layer (particularly the broken portions of the secondary particles of the positive electrode active material) can be improved by the conductive film. This makes it possible to reduce a positive electrode resistance.

The positive electrode active material layer 54 may contain not only the aforementioned active material but also, if necessary, one or more kinds of materials which can be used as components of the positive electrode active material layer 54 in a typical lithium-ion secondary battery. Examples of these materials may include a conductive material and a binder. As the conductive material, it is possible to suitably use a carbon material such as different kinds of carbon black (e.g., acetylene black (AB) and Ketjen black), graphite, coke, activated carbon, carbon fibers, carbon nanotubes or the like. As the binder, it is possible to suitably use, e.g., a vinyl halide resin such as polyvinylidene fluoride (PVDF) or the like and a polyalkylene oxide such as a polyethylene oxide (PEO) or the like. In addition to the aforementioned materials, different kinds of additives (e.g., an inorganic compound that generates a gas when overcharged, a dispersant and a thickener) may be used unless they severely impair the effects of the invention.

It is suitable that the ratio of the positive electrode active material in the entire positive electrode active material layer 54 is about 60 mass % or more (typically 60 mass % or more and 99 mass % or less). Normally, it is preferred that the ratio of the positive electrode active material in the entire positive electrode active material layer 54 is about 70 mass % or more and 95 mass % or less. In the case of using a conductive material, the ratio of the conductive material in the entire positive electrode active material layer 54 may be, for example, about 2 mass % or more and 20 mass % or less (e.g., 3 mass % or more and 10 mass % or less). In the case of using a binder, the ratio of the binder in the entire positive electrode active material layer 54 may be, for example, about 0.5 mass % or more and 10 mass % or less (e.g., 1 mass % or more and 5 mass % or less). The ratios of the positive electrode active material, the conductive material and the binder in the entire positive electrode active material layer 54 described herein refer to the ratios thereof in the positive electrode active material layer 54 kept in a dry state.

From the viewpoint of securing a sufficient battery capacity, the mass (the weight per unit area) of the positive electrode active material layer 54 provided per unit area of the positive electrode collector 52 may be 3 mg/cm² or more (e.g., 5 mg/cm² or more, typically 7 mg/cm² or more) per one surface of the positive electrode collector 52 when the positive electrode active material layer is kept dry. From the viewpoint of securing battery characteristics (e.g., input/output characteristics), the mass (the weight per unit area) of the positive electrode active material layer 54 provided per unit area of the positive electrode collector 52 may be 100 mg/cm² or less (e.g., 70 mg/cm² or less, typically 50 mg/cm² or less) per one surface of the positive electrode collector 52. In the configuration in which positive electrode active material layers 54 are formed on both surfaces of the positive electrode collector 52, the masses of the positive electrode active material layers 54 formed on the respective surfaces of the positive electrode collector 52 may be substantially identical with each other. The average thickness per one surface of the positive electrode active material layer 54 may be, e.g., 20 μm or more (typically 50 μm or more) and 200 μm or less (typically 100 μm or less). The average density of the positive electrode active material layer 54 may be, e.g., 1 g/cm³ or more (typically 1.5 g/cm³ or more) and 4.5 g/cm³ or less (typically 4.2 g/cm³ or less). The porosity of the positive electrode active material layer 54 may be, e.g., 10 volume % or more (typically 20 volume % or more) and 50 volume % or less (typically 40 volume % or less). If one or more of the aforementioned attributes are satisfied, it is possible to maintain suitable pores in the positive electrode active material layer 54 and to allow the nonaqueous electrolyte to sufficiently infiltrate into the positive electrode active material layer 54. Thus, if the attributes (the average thickness, the average density and the porosity) of the positive electrode active material layer 54 are set to fall within the aforementioned ranges, it is possible to efficiently realize the formation of the conductive film in the broken portions of the positive electrode active material. It is also possible to realize a battery capable of exercising superior battery characteristics (e.g., a high energy density and a superior input/output characteristic) during the time of normal use and capable of securing a sufficient gas generation amount at the time of overcharge.

The term “porosity” used herein refers to a value obtained by dividing a total pore volume (cm³) measured with a mercury porosimeter by an apparent volume of the active material layer (cm³) and then multiplying the divided total pore volume (cm³) by 100. The apparent volume can be calculated by the product of a plan-view area (cm²) and a thickness (cm). More specifically, for example, a positive electrode sheet to be measured is first cut into a square shape or a rectangular shape by a punch or a cutter. Then, the plan-view area (cm²) and the thickness (cm) of the positive electrode active material layer of the sample thus cut are measured. An apparent volume is calculated by multiplying the plan-view area (cm²) and the thickness (cm). The thickness can be measured by, e.g., a micrometer or a thickness meter (e.g., a rotary caliper meter).

A method for manufacturing the positive electrode 50 is not particularly limited and may be implemented, for example, by the following manner. First, a paste or slurry composition (slurry for the formation of a positive electrode active material layer) is prepared by dispersing a positive electrode active material and a material used as needed in a suitable solvent. Then, the slurry for the formation of a positive electrode active material layer thus prepared is applied on the positive electrode collector 52 having an elongated shape. The solvent contained in the slurry is removed. As result, it is possible to produce a positive electrode 50 in which the positive electrode active material layer 54 is formed on the positive electrode collector 52. As the solvent, it is possible to use an aqueous solvent and an organic solvent. For example, N-methyl-2-pyrrolidone (NMP) may be used as the solvent. The operation of applying the slurry can be performed by, for example, a suitable coating device such as a gravure coater, a slit coater, a die coater, a comma coater, a dip coater or the like. Removal of the solvent can also be performed by conventional typical means (e.g., thermal drying or vacuum drying).

As described above, the attributes (the average thickness, the average density and the porosity) of the positive electrode active material layer 54 can be adjusted by, for example, subjecting the positive electrode sheet 50 to a suitable press process after the positive electrode active material layer 54 is formed. In the press process, it may be possible to employ various kinds of well-known press methods such as a roll press method, a plate press method, or the like. The press process may be performed once or two or more times.

The negative electrode 60 includes the negative electrode collector 62 and the negative electrode active material layer which is formed on the negative electrode collector 62 and which contains at least a negative electrode active material. The negative electrode 60 according to the present embodiment is not particularly limited. It may be possible to suitably use a negative electrode which can be used in a well-known lithium-ion battery. Examples of the negative electrode collector 62 which makes up the negative electrode 60 may include a copper foil and so forth. As the negative electrode active material, it may be possible to use, e.g., a carbon material such as graphite, hard carbon, soft carbon or the like. The negative electrode active material layer 64 may contain components other than the active material, e.g., a binder and a thickener. As the binder, it may be possible to use styrene butadiene rubber (SBR) or the like. As the thickener, it may be possible to use, e.g., carboxymethyl cellulose (CMC) or the like. The negative electrode 60 can be formed by, e.g., the same method as the forming method of the positive electrode 50. That is to say, the negative electrode 60 can be formed by dispersing a negative electrode active material having a suitable particle diameter, a binder, etc., in a suitable solvent (e.g., ion-exchanged water), preparing a paste (slurry) composition, applying a suitable amount of the composition on the surface of the negative electrode collector 62, and drying the composition thus applied to remove the solvent. If necessary, the attributes of the negative electrode active material layer 64 may be adjusted by subjecting the negative electrode active material layer 64 to a suitable press process.

The separators 70 according to the present embodiment are not particularly limited and may be the same as the separators provided in a conventional lithium-ion secondary battery as long as the separators electrically isolate (or insulate) the positive electrode 50 from the negative electrode 60 and have a nonaqueous electrolyte retaining function and a shutdown function. Preferred examples of the separators 70 may include porous sheets (films) made of a resin such as polyethylene (PE), polypropylene (PP), polyester, cellulose, polyamide, or the like. The porous sheets may have a monolayer structure or a laminated structure of two or more layers (e.g., a three-layer structure in which PP layers are laminated on both surfaces of a PE layer).

Typically, as the nonaqueous electrolyte, it may be possible to use a nonaqueous electrolyte prepared by adding a supporting salt, difluorophosphate and an overcharge additive to an organic solvent (or a nonaqueous solvent). The nonaqueous electrolyte shows a liquid phase at a normal temperature (e.g., 25° C.). In one preferred embodiment, the nonaqueous electrolyte always shows a liquid phase under a use environment of the battery (e.g., under a temperature environment of −30° C. to 60° C.).

As the nonaqueous solvent, it may be possible to use, without limitation, an organic solvent, such as carbonates, ethers, esters, nitriles, sulfones, lactones, or the like, which is used in an electrolyte of a typical lithium-ion secondary battery. Specific examples of the nonaqueous solvent include ethylene carbonate (EC), propylene carbonate (PC), diethyl carbonate (DEC), dimethyl carbonate (DMC) and ethyl methyl carbonate (EMC). These nonaqueous solvents may be used either independently or in combination. One preferred example of the nonaqueous solvents may include carbonates-based nonaqueous solvents. Among them, it may be possible to suitably use EC having a high dielectric constant and DMC or EMC having a high oxidation potential (a wide potential window). For example, as the nonaqueous solvent, it may be possible to desirably use a nonaqueous solvent which contains one or more kinds of carbonates and in which the total volume of carbonates is 60 volume % or more (preferably 75 volume % or more, more preferably 90 volume % or more, or substantially 100 volume %) of the total volume of the nonaqueous solvent.

The supporting salt is not particularly limited as long as it contains charge carriers (typically lithium ions). It may be possible to use one or more kinds of supporting salts used in a typical lithium-ion secondary battery. Examples of the supporting salt may include a lithium salt such as LiPF₆, LiBF₄, LiClO₄, LiAsF₆, Li(CF₃SO₂)₂N, LiCF₃SO₃, or the like. LiPF₆ is particularly preferred as the supporting salt. Preferably, the nonaqueous electrolyte is prepared such that the concentration of the supporting salt falls within a range of 0.7 mol/L to 1.3 mol/L.

As the difluorophosphate, it may be possible to use various kinds of salts having difluorophosphate anions (PO₂F₂⁻). Cations (counter cations) of the difluorophosphate may be any one of inorganic cations and organic cations. Examples of the inorganic cations may include cations of alkali metal such as Li, Na, K, or the like and cations of alkaline earth metal such as Be, Mg, Ca, or the like. Examples of the organic cations may include cations of ammonium such as tetraalkyl ammonium, trialkyl ammonium, or the like. In usual cases, it may be possible to desirably use a salt having inorganic cations. In the technology disclosed herein, it may be possible to suitably use lithium difluorophosphate (LiPO₂F₂).

The concentration of the difluorophosphate contained in the nonaqueous electrolyte used in the aforementioned battery configuration is not particularly limited as long as the concentration is high enough to form the DFP film on the surface of the positive electrode active material. For example, the concentration of the difluorophosphate may be set to fall within a range of 0.025 mol/L or more (e.g., 0.05 mol/L or more) and 0.10 mol/L or less (e.g., 0.08 mol/L or less). If the concentration of the difluorophosphate in the nonaqueous electrolyte is much lower than 0.025 mol/L, the formability of the DFP film is impaired and the effect of suppressing the formation of the LiF film on the surface of the positive electrode active material is reduced. On the other hand, if the concentration of the difluorophosphate is much higher than 0.10 mol/L, the apparent lithium salt concentration in the nonaqueous electrolyte is increased and the amount of the overcharge additive (e.g., biphenyl or cyclohexyl benzene) dissolvable in the nonaqueous electrolyte is reduced. Thus, there is a possibility that the overcharge additive and the nonaqueous electrolyte are separated from each other (especially, under a low temperature environment).

The difluorophosphate is used in forming the DFP film on or near the surface of the positive electrode active material during the time of charging (e.g., in the first charging step and the conditioning step to be described later, or during the use of the battery). The lithium-ion secondary battery disclosed herein may be in a state where some or substantially all of the difluorophosphate existing in the nonaqueous electrolyte is electrolyzed after the below-described conditioning step or after the start of use of the battery. That is to say, the nonaqueous electrolyte existing in the battery available after the first charging, after the conditioning step or after the start of use may have a composition which contains a small amount of difluorophosphate (or difluorophosphate ions) or which contains substantially no difluorophosphate. By the expression “contains substantially no difluorophosphate (ions)” used herein, it is meant that, in the IC analysis, the amount of the difluorophosphate ions is not greater than a detection limit value.

Whether the battery is constructed using the nonaqueous electrolyte which contains difluorophosphate can be identified by, for example, collecting a measurement sample from the constituent members (the positive and negative active material layers, etc.) of the battery and detecting a P element by a measurement method such as IC, ICP-AES, XAFS, MS, or the like as described above in respect of the measurement method of the film amount of the DFP film formed on the surface of the positive electrode active material. According to this method, even when the nonaqueous electrolyte which contains a phosphorus-containing salt, e.g., LiPF₆, as the supporting salt is used, it is possible to detect a P element derived from difluorophosphate (e.g., LiPO₂F₂) as being distinguished from a P element derived from LiPF₆. When quantifying the amount of the difluorophosphate in the nonaqueous electrolyte used in fabricating the battery (the amount of the difluorophosphate supplied into the battery case or the concentration of the difluorophosphate in the nonaqueous electrolyte), it may be possible to suitably use the measurement of a P element conducted by an IC superior in quantitativeness. For example, the amount of the difluorophosphate in the nonaqueous electrolyte used in fabricating the battery can be calculated by quantifying, with an IC, the amount of the difluorophosphate and chemical species derived from decomposition products thereof contained in the nonaqueous electrolyte remaining in the battery and the constituent members (e.g., the surfaces of the positive and negative electrode active materials) of the battery.

As the nonaqueous electrolyte used in fabricating the battery according to the present embodiment, it may be possible to suitably use a nonaqueous electrolyte which contains overcharge additives (an overcharge inhibitor and a gas generating agent) capable of being decomposed to generate a gas when the battery voltage exceeds a predetermined voltage. The overcharge additives may have a function of forming a conductive film as well as a function as a gas generating agent at the time of overcharge. In this regard, the overcharge additives (an overcharge inhibitor and a gas generating agent) are not particularly limited as long as they are compounds which have an oxidation potential (vs. Li/Li⁺) equal to or higher than a charge upper limit potential of a positive electrode (an operation voltage of a battery) and which can be decomposed to generate a gas when a battery potential exceeds this oxidation potential (when a battery comes into an overcharged state). It may be possible to use one or more kinds of overcharge additives selected from those used in similar applications. More specifically, for example, it is preferred that the overcharge additives have an oxidation potential (vs. Li/Li⁺) which is about 0.1 V (typically 0.2 V, e.g., 0.3 V) higher than a charge upper limit potential of a positive electrode (an operation voltage of a battery). It is more preferred that two or more kinds of compounds differing in oxidation potential from one another are used in combination.

Specifically, examples of the compounds may include aromatic compounds such as a biphenyl compound, an alkyl biphenyl compound, a cycloalkylbenzene compound, a alkylbenzene compound, an organic phosphorus compound, a fluorine-atom-substituted aromatic compound, a carbonate compound, a cyclic carbamate compound, alicyclic hydrocarbon, and the like. More specifically, examples of the compounds may include biphenyl (BP), cyclohexylbenzene (CHB), trans-butyl cyclohexyl benzene, cyclopentyl benzene, t-butyl benzene, t-aminobenzene, terphenyl, 2-fluorobiphenyl, 3-fluorobiphenyl, 4-fluorobiphenyl, 4,4′-difluorobiphenyl, o-cyclohexyl fluorobenzene, p-cyclohexyl fluorobenzene, tris-(t-butyl phenyl) phosphate, phenyl fluoride, 4-fluorophenyl acetate, diphenyl carbonate, methyl phenyl carbonate, bis tertiary butyl phenyl carbonate, diphenyl ether, and dibenzofuran.

For example, in a battery in which a charge upper limit potential (vs. Li/Li⁺) of a positive electrode is set at about 4.0 to 4.3 V, it may be possible to desirably use aromatic compounds such as biphenyl (oxidation potential: 4.5 (vs. Li/Li⁺)), cyclohexyl benzene (oxidation potential: 4.6 (vs. Li/Li⁺)), diphenyl carbonate (oxidation potential: 5.0 (vs. Li/Li⁺)), methyl phenyl carbonate (oxidation potential: 4.8V (vs. Li/Li⁺)), and the like. These overcharge additives have an oxidation potential close to a charge upper limit potential. Thus, the overcharge additives allow oxidative decomposition to occur in a positive electrode at an early stage of overcharge. This makes it possible to rapidly generate a gas (typically a hydrogen gas). Such compounds are easy to take a conjugated system and are easy to give and receive electrons. Therefore, the compounds can generate a large amount of gas. This makes it possible to rapidly and accurately operate a CID and to further increase the reliability of a battery. Among the aromatic compounds mentioned above, two or more kinds of compounds may be used in combination.

As the nonaqueous electrolyte used in the battery configuration according to the present embodiment, it may be possible to suitably use a nonaqueous electrolyte which contains biphenyl as an overcharge additive. Biphenyl existing in the nonaqueous electrolyte is decomposed and polymerized more efficiently than other overcharge additives on a positive electrode active material surface or in the vicinity thereof, thereby forming a conductive film in broken portions of a positive electrode active material. In order to suitably demonstrate the effects of the invention, it may be possible to suitably use a nonaqueous electrolyte which contains one or more kinds (e.g., two or more kinds) of overcharge additives other than biphenyl. As these overcharge additives, it may be possible to suitably use aromatic compounds (overcharge additives) having an oxidation potential (or a gas generation potential) higher than that of biphenyl. Examples of these overcharge additives (having an oxidation potential higher than that of biphenyl) may include cyclohexyl benzene, diphenyl carbonate, methyl phenyl carbonate or the like. If the overcharge additives having an oxidation potential (or a gas generation potential) higher than that of biphenyl are additionally contained in the nonaqueous electrolyte, a gas generation amount large enough to operate a CID at the time of overcharge can be secured even in a lithium-ion secondary battery in which biphenyl existing in the nonaqueous electrolyte has been already used up for the formation of a conductive film on the positive electrode active material surface (typically the broken portions) as described above. This is because aromatic compounds (overcharge additives) other than biphenyl still exist in the nonaqueous electrolyte.

The concentration of the overcharge additive (including biphenyl) contained in the nonaqueous electrolyte used in the aforementioned battery configuration (the total concentration of two or more kinds of overcharge additives) is not particularly limited. From the viewpoint of securing a gas amount large enough to operate a CID, it is preferred that the concentration of the overcharge additive is about 4 mass % or more (typically 4.2 mass % or more) based on 100 mass % of the nonaqueous electrolyte. The overcharge additive is typically a non-polar compound. If the overcharge additive is excessively added to the nonaqueous electrolyte as a polar solvent, there is a possibility that the overcharge additive and the nonaqueous electrolyte are separated from each other (particularly, under a low temperature environment). From this viewpoint, it is preferred that the concentration of the overcharge additive contained in the nonaqueous electrolyte used in the aforementioned battery configuration is about 5 mass % or less (typically 4.8 mass % or less) based on 100 mass % of the nonaqueous electrolyte.

The concentration of biphenyl contained in the nonaqueous electrolyte used in fabricating the aforementioned battery may be 0.5 mass % or more (e.g., 0.6 mass % or more) and 1 mass % or less (e.g., 0.8 mass % or less) based on 100 mass % of the nonaqueous electrolyte. If the concentration of biphenyl is much lower than 0.5 mass %, there is a possibility that it becomes impossible to form a conductive film in an amount large enough to cover the broken portions of the positive electrode active material. On the other hand, if the concentration of biphenyl is much higher than 1.0 mass %, there is a possibility that, particularly under a high temperature environment, an elution reaction of transition metal existing in the positive electrode active material (a reaction by which biphenyl is oxidized on the positive electrode active material surface and transition metal existing in the positive electrode active material is reduced as a result) occurs in the positive electrode, thereby lowering the reaction efficiency of a battery reaction and making it difficult to secure an overcharge gas generation amount.

In the case of using the aforementioned overcharge additive, e.g., two or more kinds of overcharge additives, the additive having a lowest oxidation potential (typically biphenyl) is preferentially decomposed and polymerized on the positive electrode active material surface or in the vicinity thereof in the conditioning step to be described later and is used for the formation of a conductive film on the positive electrode active material surface (typically the surface of a film containing PO₂F₂⁻ mentioned above). Thus, after the below-described conditioning step or after the start of use of the battery, the lithium-ion secondary battery disclosed herein may be in a state where some or substantially all of the overcharge additive (typically biphenyl) existing in the nonaqueous electrolyte and having a low oxidation potential is decomposed and polymerized to form a conductive film. That is to say, the nonaqueous electrolyte existing in the battery available after the conditioning step or after the start of use may have a composition which contains only a small amount of the overcharge additive (typically biphenyl) having a low oxidation potential or contains substantially no overcharge additive (typically biphenyl) having a low oxidation potential. By the expression “contains substantially no overcharge additive (typically biphenyl) having a low oxidation potential” used herein, it is meant that, in a suitable measurement method (e.g., an IC analysis), the amount of the compound (typically the ions of the compound) is not greater than a detection limit value.

Further, whether the battery is constructed using the nonaqueous electrolyte which contains an overcharge additive provided for the formation of a conductive film (e.g., an overcharge additive (typically biphenyl) having the lowest oxidation potential in the case of using two or more kinds of overcharge additives) can be identified by, for example, collecting a measurement sample from the constituent members (the positive and negative active material layers, etc.) of the battery and detecting an overcharge additive provided for the formation of a conductive film or a decomposition product thereof (typically a compound including a benzene ring) by a measurement method such as IC, ICP-AES, XAFS, MS, or the like. According to this method, even when two or more kinds of overcharge additives are used, it is possible to detect them in a distinguishable manner. For example, even when a nonaqueous electrolyte which contains not only biphenyl but also an overcharge additive (e.g., cyclohexyl benzene) other than biphenyl is used, it is possible to distinguishably detect a compound containing a benzene ring derived from an overcharge additive other than biphenyl and a compound containing a benzene ring derived from biphenyl. When quantifying the amount of the respective overcharge additives in the nonaqueous electrolyte used in fabricating the battery (the amount of the overcharge additives supplied into the battery case or the concentration of the overcharge additives in the nonaqueous electrolyte), it may be possible to suitably use an IC analysis superior in quantitativeness. For example, the amount of the overcharge additives (typically biphenyl) in the nonaqueous electrolyte used in fabricating the battery can be calculated by quantifying, with an IC, the amount of the respective overcharge additives (typically biphenyl) and chemical species derived from decomposition and polymerization thereof contained in the nonaqueous electrolyte remaining in the battery and constituent members (e.g., the surfaces of the positive and negative electrode active materials) of the battery.

As described above, some of the overcharge additives (typically the overcharge additive having a low oxidation potential, e.g., biphenyl) is used for the formation of a conductive film. Accordingly, as a matter of course, the concentration of all the overcharge additives existing in the nonaqueous electrolyte of the battery available after the conditioning step or after the start of use may be lower than the concentration of all the overcharge additives existing in the nonaqueous electrolyte used in fabricating the battery described above. Typically, it can be appreciated that the nonaqueous electrolyte of the battery available after the below-described conditioning step or immediately after the start of use contains the overcharge additives in an amount equal to the amount obtained by subtracting the amount of the overcharge additive (e.g., biphenyl) provided for the formation of the conductive film on the positive electrode active material surface from the content of all the overcharge additives existing in the nonaqueous electrolyte used in fabricating the battery.

The nonaqueous electrolyte may further contain various kinds of additives unless the additives heavily impair the effect of the invention. These additives may be used for one or more purposes of, e.g., improving the output performance of the battery, improving the preservability (suppression of a capacity reduction during preservation), improving the cycle characteristics and improving the initial charging/discharging efficiency. Examples of preferred additives may include a sulfonic acid compound, an oxalate complex compound containing boron atoms and/or phosphorus atoms, vinylene carbonate (VC), and fluoroethylene carbonate (FEC).

Next, a description will be made on a lithium-ion secondary battery manufacturing method according to the invention. One preferred embodiment for manufacturing the lithium-ion secondary battery 100 configured as above will be described with reference to the drawings. This description is not intended to limit the lithium-ion secondary battery manufacturing method of the invention to the following embodiment.

Generally speaking, the manufacturing method of the lithium-ion secondary battery 100 according to the present embodiment includes a battery assembly fabricating step, a first charging step in which a battery is fabricated by performing a first charging with respect to the battery assembly, and a conditioning step in which the battery subjected to the first charging is charged and discharged at least once. Hereinafter, the manufacturing method according to the present embodiment will be described in more detail.

First, a description will be made on the battery assembly fabricating step. In this step, a battery assembly is fabricated by putting a positive electrode 50, a negative electrode 60 and a nonaqueous electrolyte into a battery case 30. The aforementioned electrodes may be used as the positive electrode 50 and the negative electrode 60. For example, the battery assembly can be fabricated by preparing an electrode body 20 provided with the positive electrode 50 and the negative electrode 60 as described above, putting the electrode body 20 into the battery case 30, and then pouring the nonaqueous electrolyte through a nonaqueous electrolyte pouring port formed in the battery case 30.

As described above, the nonaqueous electrolyte includes a nonaqueous solvent which contains a supporting salt, difluorophosphate and an overcharge additive. The aforementioned ones may be suitably selected and used as the constituent materials of the nonaqueous electrolyte (the nonaqueous solvent, the supporting salt, the difluorophosphate and the overcharge additive). Biphenyl may be suitably used as the overcharge additive. The difluorophosphate and the overcharge additive (typically biphenyl) are provided for the formation of a film on a positive electrode active material surface at the first charging step and/or the conditioning step to be described later. The nonaqueous electrolyte may further contain an overcharge additive other than biphenyl. It is preferred that this overcharge additive is a compound having an oxidation potential (or a gas generation potential) higher than that of biphenyl.

Subsequently, the first charging step will be described. In this step, prior to performing the conditioning step to be described later, a first charging process for applying a current between the positive electrode and the negative electrode is performed with respect to the battery assembly fabricated as above. By performing the charging process, electricity is stored in the battery assembly, whereby the battery assembly can be used as a battery. In other words, a battery is fabricated.

The first charging process may be performed under the same condition as used in the lithium-ion secondary battery fabricating step of the related art. For example, in the first charging process, charging is typically performed until the SOC becomes about 100% (typically 80% or more and 100% or less, e.g., 90% or more and 100% or less). In other words, charging is performed to about 100% (typically 80% or more and 100% or less, e.g., 90% or more and 100% or less) of a charge upper limit potential (a charge end potential or a fully-charged battery potential).

The charging in this step may be performed by, for example, a method (a constant current charging method or a CC charging method) in which a battery is charged at a constant current until a voltage between the positive electrode and the negative electrode reaches a predetermined value (or until a potential of the positive electrode reaches a predetermined value or a predetermined SOC), or a method (a constant current/constant voltage charging method or a CCCV charging method) in which a battery is charged at a constant current until the voltage between the positive electrode and the negative electrode reaches the predetermined value and is then charged at a constant voltage. In either of the charging methods, a charging rate when charging the battery at a constant current is not particularly limited and may be set appropriately. If charging is performed at an unduly low charging rate, there is a possibility that the process efficiency is reduced. On the other hand, if charging is performed at an unduly high charging rate, there is a possibility of deterioration of the active material. For that reason, it is preferred that the charging rate is, for example, 1/20 C or more (e.g., 1/2 C or more) and 10 C or less (typically 5 C or less, e.g., 2 C or less). For example, charging can be performed at a charging rate of 1 C.

Subsequently, the conditioning step will be described. In this step, discharging to a predetermined lowest SOC and charging to a predetermined highest SOC are performed at least once with respect to the battery (battery assembly). By performing this charging/discharging process (discharging/charging process), it is possible to form broken portions in the positive electrode active material (typically the secondary particles of the positive electrode active material) and to efficiently form a suitable conductive film in the broken portions. Referring to FIGS. 2 and 3, it can be noted that, by performing the conditioning step, the broken portions which do not exist in the secondary particles of the positive electrode active material available before the conditioning step (see FIG. 2) are formed in the secondary particles of the positive electrode active material available after the conditioning step (see FIG. 3).

The repetition frequency of the conditioning step is not particularly limited. For example, one cycle of charging a battery from a predetermined lowest SOC to a predetermined highest SOC and then discharging the battery to the lowest SOC may be performed at least once. From the viewpoint of forming a larger number of broken portions and reliably forming a conductive film, the charging/discharging cycle may be repeated a multiple number of times (e.g., two times or more and ten times or less, preferably four times or so).

The highest SOC is set as a value which realizes a high potential capable of forming a conductive film derived from an overcharge additive. That is to say, the highest SOC may be set equal to or higher than an SOC at which a polymerization reaction (or a decomposition/polymerization reaction) of an overcharge additive provided for the formation of a conductive film is started. In other words, the highest SOC may be set equal to or higher than an SOC corresponding to a polymerization initiating potential (or an oxidation potential (vs. Li/Li⁺)) of the overcharge additive. For example, the highest SOC may be an SOC of 105% or more (typically 110% or more). In the case of using a nonaqueous electrolyte which contains an overcharge additive differing from the overcharge additive provided for the formation of the conductive film (e.g., an overcharge additive added for the purpose of generating a gas when overcharged), it is preferred that, in order to prevent decomposition of the different overcharge additive, the highest SOC is set at an SOC which is lower than an oxidation potential (vs. Li/Li⁺) of the different overcharge additive or the SOC corresponding to the oxidation potential. For example, the highest SOC may be set at an SOC of 125% or less (typically 120% or less).

Furthermore, the lowest SOC is not particularly limited as long as the lowest SOC falls within a range in which a volume change of the positive electrode active material large enough to form the broken portions on the surface of the positive electrode active material (typically the secondary particles) can be generated by performing a charging/discharging process in which discharging to the lowest SOC and charging to the highest SOC are repeated. More specifically, the lowest SOC is set as a value which makes sure that a volume change rate available when a lattice volume of a crystallite of the positive electrode active material at the lowest SOC is compared with a lattice volume of a crystallite of the positive electrode active material at the highest SOC becomes larger than 0% and equal to or smaller than 3%. For example, the lowest SOC may be set at an SOC which is 10% or more (preferably, 20% or more, more preferably 30% or more) lower than the highest SOC. That is to say, the lowest SOC may be set such that a difference between the highest SOC and the lowest SOC becomes 10% or more (preferably, 20% or more, more preferably 30% or more). By setting the lowest SOC as above, it is possible to secure a difference between the lowest SOC and the highest SOC which is suitable for the formation of the broken portions of the positive electrode active material. If the lowest SOC is set too low, the efficiency of the conditioning step is reduced (the battery manufacturing efficiency is reduced). For that reason, it is preferred that the lowest SOC is set such that the difference between the lowest SOC and the highest SOC becomes 70% or less (preferably 60% or less, more preferably 50% or less).

For example, the formation of the broken portions and the formation of the conductive film can be suitably performed by setting the highest SOC at an SOC of 110% or more and setting the lowest SOC at an SOC of 80% or less.

Specifically, in the battery in which the charge upper limit potential (vs. Li/Li⁺) of the positive electrode is set at about 4.1 V, the highest SOC in the case where biphenyl is used as the overcharge additive provided for the formation of the conductive film may be set at an SOC of, e.g., 105% or more and 115% or less (typically at an SOC of about 110%). At this time, the lowest SOC may be set at an SOC of, e.g., 60% or more and 95% or less (typically 70% or more and 85% or less, e.g., 80%).

If charging to an SOC higher than the lowest SOC has been already performed at the first charging step, a first conditioning step may be performed by carrying out a charging process to a predetermined highest SOC and then carrying out a discharging process to a predetermined lowest SOC. That is to say, a part of the conditioning step may be performed in an overlapping relationship with (or simultaneously with) a part of the first charging step. Alternatively, prior to performing the conditioning step after the first charging, the charge state of the battery may be adjusted to a predetermined lowest SOC (discharging may be performed in the case where the charge state of the battery after the first charging is higher than the lowest SOC, or charging may be performed in the case where the charge state of the battery after the first charging is lower than the lowest SOC). Thereafter, the conditioning step is performed. From the viewpoint of formability of the broken portions on the surface of the positive electrode active material (typically the secondary particles), it is preferred that a charging/discharging process is performed two or more times by performing a part of the conditioning step in an overlapping relationship with (or simultaneously with) a part of the first charging step as described above, or a charging/discharging process is performed one or more times after the charge state of the battery is once adjusted to the predetermined lowest SOC after the first charging as described above.

The temperature (environment temperature) at the time of performing the conditioning step is not particularly limited and may be set at, e.g., 35° C. or more and 80° C. or less, typically 40° C. or more and 70° C. or less. Preferably, the conditioning step may be performed at 60° C. By performing the conditioning step under this temperature condition, it is possible to form a high-quality (e.g., thin and uniform) conductive film. If the temperature for performing the conditioning step is too low, there is a possibility that the formability of the film (the film amount and the film quality) is reduced. On the other hand, if the temperature for performing the conditioning step is too high, there is a possibility that the electrolyte (especially the solvent) is degenerated and the battery characteristics are reduced.

The charging in this step may be performed by, for example, a method (a constant current charging method or a CC charging method) in which a battery is charged at a constant current until a voltage between the positive electrode and the negative electrode reaches a predetermined value (or until a potential of the positive electrode reaches a predetermined value or a predetermined SOC) after the start of charging, or a method (a constant current/constant voltage charging method or a CCCV charging method) in which a battery is charged at a constant current until the voltage between the positive electrode and the negative electrode reaches the predetermined value and is then further charged at a constant voltage. In either of the charging methods, a charging rate when charging the battery at a constant current is not particularly limited and may be set appropriately. If charging is performed at an unduly low charging rate, there is a possibility that the process efficiency is reduced. On the other hand, if charging is performed at an unduly high charging rate, there is a possibility that the active material is degraded or the quality of the film is reduced. For that reason, it is preferred that the charging rate is, for example, 0.1 C or more (e.g., 0.5 C or more) and 10 C or less (typically 5 C or less, e.g., 2 C or less). This makes it possible to accurately form a suitable film in a short period of time.

From the viewpoint of improving the formability of the conductive film, it is preferred that the charging/discharging process is performed by the CCCV charging method. The time for performing the CV charging is not particularly limited. If the CV charging time is too short, there is a possibility that the formation of the film becomes insufficient or uneven. On the other hand, if the CV charging time is too long, there is a possibility that the formation of the film is excessively performed depending on the charging conditions and the internal resistance (initial resistance) of the battery may be increased. Since a suitable charging time may vary depending on the configuration of the battery or the charging process conditions, it is preferred that the charging time is decided on a case-by-case basis by conducting a simple preliminary experiment. Alternatively, a suitable film may be formed on the surface of the positive electrode active material by charging the battery at a constant current until the battery potential reaches the predetermined potential (or voltage) and then aging (letting alone) the battery for a specified time period. This charging method is simpler than the CCCV charging method because just leaving the battery alone suffices in this charging method.

The time for performing the first charging step and the conditioning step may be appropriately set depending on different conditions such as the battery size such as the battery capacity or the like, the charging rate, the charging method, the highest SOC at the conditioning step, the lowest SOC at the conditioning step, the repetition frequency of charging and discharging, and the like.

According to the nonaqueous electrolyte secondary battery manufacturing method disclosed herein, as described above, it is possible to provide a lithium-ion secondary battery which is superior in durability (e.g., cycle characteristics) and which has high reliability (e.g., safety). Accordingly, the lithium-ion secondary battery can be suitably used as, e.g., a driving-purpose power supply mounted to a motor vehicle. The lithium-ion secondary battery is particularly suitable for use as a driving-purpose power supply of a plug-in hybrid vehicle (PHV), a hybrid vehicle (HV), an electric vehicle (EV), or the like. According to the invention, there is provided a motor vehicle which includes the lithium-ion secondary battery manufactured by the nonaqueous electrolyte secondary battery manufacturing method disclosed herein, preferably as a power source (typically a battery pack composed of a plurality of secondary batteries electrically connected to one another).

Next, a description will be made on examples (test examples) according to the invention. However, this description is not intended to limit the invention to such examples.

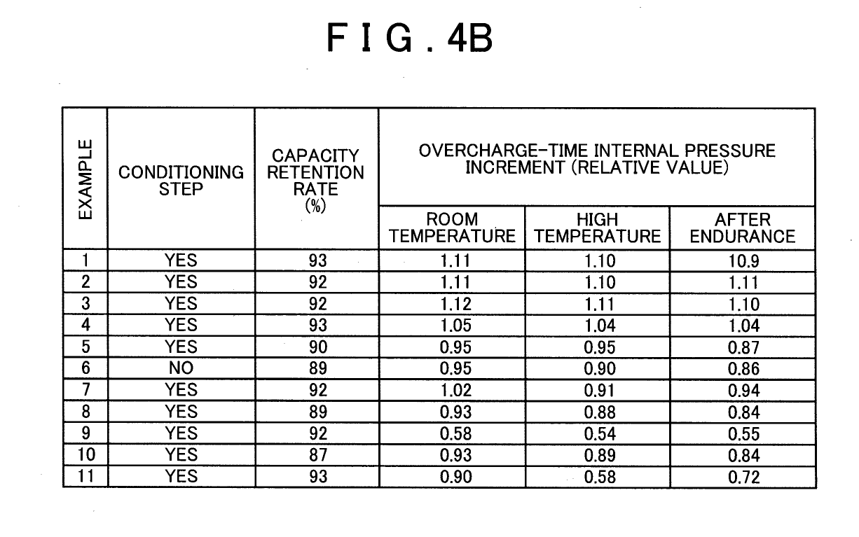

Lithium-ion secondary batteries (nonaqueous electrolyte secondary batteries) of examples 1 to 11 shown in FIGS. 4A and 4B were fabricated using the materials and processes described below.

Formation of a positive electrode active material layer was carried out in the following procedure. First, a particulate LiNi_{0.33}Co_{0.33}Mn_{0.33}O₂ (LNCM) in which a change rate (%) available when a lattice volume of a crystallite of a positive electrode active material at an SOC of 80% is compared with a lattice volume of a crystallite of a positive electrode active material at an SOC of 110% satisfies a “LATTICE VOLUME CHANGE RATE (%)” shown in FIG. 4A was prepared as a positive electrode active material. The change rate can be found by an equation: change rate (%)=(lattice volume of positive electrode active material at SOC 80%—lattice volume of positive electrode active material at SOC 110%) lattice volume of positive electrode active material at SOC 80%×100. The aforementioned positive electrode active material (LNCM), acetylene black (AB) as a conductive material, and polyvinylidene fluoride (PVDF) as a binder were put into a kneading machine such that the mass ratio of these materials, LNCM:AB:PVDF, becomes equal to 94:3:3, and were kneaded while adjusting a viscosity with N-methylpyrrolidone (NMP), thereby preparing a slurry for the formation of a positive electrode active material layer. A positive electrode sheet was prepared by coating the slurry on both surfaces of an aluminum foil (or a positive electrode collector) having a thickness of 15 μm in a band shape, drying the slurry and pressing the slurry. At this time, the amount of the positive electrode active material layer applied on the positive electrode collector was set to become 30 mg/cm² per one surface of the positive electrode collector when the slurry is dried. In addition, the active material density of the positive electrode active material layer was set to become 3.0 g/cm³.

Preparation of a negative electrode was carried out in the following procedure. Spherical graphite (C) as a negative electrode active material, styrene-butadiene rubber (SBR) as a binder, and carboxymethyl cellulose (CMC) as a thickening agent were put into a kneading machine such that the mass ratio of these materials, C:SBR:CMC, becomes equal to 98:1:1, and were kneaded while adjusting a viscosity with ion-exchanged water, thereby preparing a slurry for the formation of a negative electrode active material layer. A negative electrode sheet was prepared by coating the slurry on both surfaces of a copper foil (or a negative electrode collector) having a thickness of 10 μm in a band shape, drying the slurry and pressing the slurry. At this time, the amount of the negative electrode active material layer applied on the negative electrode collector was set to become 15 mg/cm² per one surface of the negative electrode collector when the slurry is dried. In addition, the active material density of the positive electrode active material layer was set to become 1.4 g/cm³.

A wound electrode body having a flat shape was prepared by longitudinally superimposing the positive electrode and the negative electrode prepared in the aforementioned manner, through two separators having a three-layer structure in which porous polypropylene layers are formed on both surfaces of a porous polyethylene layer, winding the positive electrode, the negative electrode and the separators in a longitudinal direction, and then pressing and crushing the positive electrode, the negative electrode and the separators.

Subsequently, the wound electrode body was provided inside a battery case. A nonaqueous electrolyte was poured into the battery case from a pouring port of the battery case. The pouring port was hermetically sealed. A nonaqueous electrolyte prepared by dissolving LiPF₆ as a supporting salt at a concentration of 1.1 mol/L in a mixed solvent which contains ethylene carbonate (EC), dimethyl carbonate (DMC) and ethyl methyl carbonate (EMC) at a volume ratio of EC:DMC:EMC=30:40:30 and adding LiPO₂F₂, CHB and BP to the mixed solvent was used as the aforementioned nonaqueous electrolyte. In this regard, the additional amount of LiPO₂F₂ was set such that the concentration of LiPO₂F₂ in the nonaqueous electrolyte becomes 0.54 mass %. The additional amount of BP was set such that based on 100 mass % of nonaqueous electrolyte, the concentration of BP in the nonaqueous electrolyte becomes a concentration shown to read “BIPHENYL CONCENTRATION (mass %)” in FIG. 4A. The additional amount of CHB was set such that based on 100 mass % of nonaqueous electrolyte, the concentration of CHB in the nonaqueous electrolyte becomes a concentration shown to read “OVERCHARGE ADDITIVE CONCENTRATION (mass %)” in FIG. 4A. In this way, the battery assemblies according to examples 1 to 11 were fabricated.

Batteries were produced by performing a first charging with respect to the battery assemblies according to examples 1 to 11 fabricated as above. Specifically, under a temperature condition of 25° C., a constant current/constant voltage charging (CCCV charging) was performed at a charging rate (or a current value) of 1 C until the voltage between the positive electrode and the negative electrode becomes 1 V and, then, CCCV charging was performed at a charging rate of 1 C until the voltage between the positive electrode and the negative electrode becomes 4.1 V.

Subsequently, a conditioning step (or a charging/discharging process) was performed with respect to the batteries according to examples 1 to 5 and examples 7 to 11 which have been subjected to the first charging. Specifically, under a temperature condition of 60° C., a charging/discharging process of performing constant current charging at a charging rate of 1 C to an SOC of 110% (the highest SOC) and then performing constant current discharging at a discharging rate of 1 C to an SOC of 80% (the lowest SOC) was repeated four times. In this regard, the SOC of 110% (the highest SOC) was set as an SOC corresponding to a polymerization initiating potential (vs. Li/Li⁺) of biphenyl added to the nonaqueous electrolyte in the batteries according to the respective examples fabricated using the aforementioned materials and processes.

[Analysis of the Film Formed on the Electrode Surface]

The batteries according to the respective examples produced individually were discharged to an SOC of 0%. Thereafter, the positive electrodes were taken out by dismantling the batteries. The film amount of the DFP film formed on each of the positive electrodes was quantified. Specifically, the positive electrodes were first taken out by dismantling the respective batteries which have been subjected to the conditioning (the first charging in the case of the battery according to example 6). The positive electrodes were immersed in EMC used as the nonaqueous electrolyte for about 10 minutes and then cut into an appropriate size (herein, the shape of a circle having a diameter of 40 mm). Then, the positive electrodes thus cut (samples for IC measurement) were immersed in 50 mass % of acetonitrile (CH₃CN) solution for ten minutes. A film component derived from difluorophosphate was extracted. Then, the amount (μmol/cm²) of the DFP film (the film containing difluorophosphate ions) was measured by quantitatively analyzing the solution with an IC. An ion chromatography system (ICS-3000) made by Nippon Dionex Corp. was used as an analyzing device. The film amount (μmol/cm²) of the DFP film thus obtained was divided by the product of a BET specific surface area (m²/g) of the active material and a weight per unit area (g/cm²) of the active material, thereby calculating the film amount (μmol/m²) of the DFP film per unit surface area (1 m²) of the active material of the positive electrode. The results are indicated in the column of “FILM AMOUNT OF A FILM DERIVED FROM DIFLUOROPHOSPHATE (μmol/m²)” shown in FIG. 4A.

[Charging/Discharging Cycle Test]

Durability tests (or charging/discharging cycle tests) were conducted with respect to the batteries according to the respective examples which have been subjected to the conditioning. Thereafter, durability characteristics were evaluated by measuring capacity retention rates. Specifically, the evaluation was conducted as follows. First, with respect to the batteries according to examples 1 to 11 which have been subjected to the conditioning, a constant current/constant voltage charging (CCCV charging) was performed to 4.1 V at a current value (or a charging rate) of 1/3 C. Thereafter, a discharge capacity (or an initial battery capacity) available when the constant current/constant voltage discharging (CCCV discharging) is performed to 3 V at a current value of 1/3 C under a temperature condition of 25° C. was measured. A charging/discharging process was repeated 100 cycles with respect to the respective batteries of examples 1 to 11 which have been subjected to measurement of the initial battery capacity. The charging/discharging process was performed one cycle per day. Thus, tests were conducted for 100 days in total. The charging/discharging condition of one cycle was that, under a temperature condition of 60° C., constant current charging is performed to an SOC of 85% at a charging rate of 2 C and, then, constant current discharging is performed to an SOC of 20% at a discharging rate of 2 C. With respect to the respective lithium-ion secondary batteries which have been subjected to the charging/discharging process of 100 cycles, the discharge capacity (or the post-cycle battery capacity) available after the charging/discharging process of 100 cycles was measured in the same manner as the measurement of the initial battery capacity. Then, a capacity retention rate (%) was calculated as the ratio of the post-cycle battery capacity to the initial battery capacity. That is to say, the capacity retention rate was calculated by an equation: capacity retention rate (%)=post-cycle battery capacity÷initial battery capacity×100. The results are indicated in the column of “CAPACITY RETENTION RATE (%)” shown in FIG. 4B.

[Overcharging Test]

With respect to the batteries of the respective example which have been subjected to the conditioning (the batteries of the respective examples which are not subjected to the charging/discharging cycle test) and the batteries of the respective examples which have been subjected to the charging/discharging cycle test, an overcharge-time gas generation amount was evaluated by measuring an overcharge-time battery internal pressure. First, with respect to the batteries of the respective examples which have been subjected to the conditioning, constant current charging was performed to an SOC of 100% at a charging rate of 1 C under a room temperature environment (25° C.) or a high temperature environment (60° C.). Thereafter, constant current charging was performed to an SOC of 145% at a charging rate of 1 C under each of the temperature conditions (under a room temperature environment (25° C.) or a high temperature environment (60° C.)). A battery internal pressure at the high SOC (the overcharged state) (a post-overcharge battery internal pressure) was measured. When an operation pressure (a preset value) of a CID is assumed to be 1.0, a relative value (times) of the overcharge-time battery internal pressure to the CID operation pressure was calculated. That is to say, an internal pressure increment was calculated by an equation: internal pressure increment=post-overcharge internal pressure÷CID operation pressure. The results are indicated in the columns of “ROOM TEMPERATURE” and “HIGH TEMPERATURE” belonging to the column of “OVERCHARGE-TIME INTERNAL PRESSURE INCREMENT (RELATIVE VALUE)” shown in FIG. 4B. With respect to the batteries of the respective examples which have been subjected to the charging/discharging cycle test, overcharging was performed under a room temperature environment (25° C.) in the same manner as applied to the batteries of the respective examples which are not subjected to the charging/discharging cycle test. Thereafter, a battery internal pressure was measured and a relative value (times) of the post-overcharge internal pressure to the CID operation pressure was calculated. The results are indicated in the column of “AFTER ENDURANCE” belonging to the column of “OVERCHARGE-TIME INTERNAL PRESSURE INCREMENT (RELATIVE VALUE)” shown in FIG. 4B.

As shown in FIG. 4B, when compared with the batteries of examples 5 and 6, the capacity retention rates of the batteries of examples 1 to 4 were large values of 92% or more. Furthermore, all the overcharge-time battery internal pressure increments under the three conditions (room temperature, high temperature and after endurance) were large values of 1.0 times or more. That is to say, it was confirmed that the securement of the durability (the capacity retention rate after the cycle test) and the securement of the overcharge-time gas generation amount can be made compatible at a high level by fabricating the battery assembly using the nonaqueous electrolyte which contains the overcharge additive and the difluorophosphate, subjecting the battery assembly to the first charging process, and then performing the conditioning step at which the discharging to the predetermined lowest SOC and the charging to the predetermined highest SOC are carried out at least once. This means that, according to the invention, it is possible to form intentionally broken portions in the positive electrode active material (typically the secondary particles of the positive electrode active material) and to efficiently form a suitable conductive film in the broken portions.

In the batteries according to examples 1 to 4, the volume change rate available when a lattice volume of a crystallite of the positive electrode active material at an SOC of 80% is compared with a lattice volume of a crystallite of the positive electrode active material at an SOC of 110% was larger than 0% and equal to or smaller than 3%. Further, it was possible to form a conductive film derived from an overcharge additive (here, biphenyl) by charging the batteries to an SOC of 110%. That is to say, when producing the batteries according to examples 1 to 4, the SOC of 80% and the SOC of 110% were values suitable for the predetermined lowest SOC and the predetermined highest SOC in the invention.

Next, a suitable amount of the total content of the overcharge additives existing in the nonaqueous electrolyte used in fabricating the batteries will be reviewed while comparing the batteries of examples 1, 4 and 9 with one another. The batteries of examples 1, 4 and 9 differed from one another in the total content of the overcharge additives existing in the nonaqueous electrolyte used in fabricating the respective batteries. In the battery of example 9 in which the total content of the overcharge additives existing in the nonaqueous electrolyte used in fabricating the battery (here, the total sum of the content of biphenyl and the content of CHB, namely the total sum of the concentration of biphenyl and the concentration of the overcharge additive shown in FIG. 4A) is relatively low, namely 3 mass % or less based on 100 mass % of the nonaqueous electrolyte, the capacity retention rate exhibited a large value of 92% or more. However, all the overcharge-time battery internal pressure increments (relative values) under the three conditions (room temperature, high temperature and after endurance) were significantly reduced to less than 0.6 times. Presumably, this is because the content of the overcharge additives existing in the nonaqueous electrolyte before the charging/discharging process was small and because, when overcharged, a gas could not be generated in an amount large enough to operate a CID. From the foregoing, it can be noted that, if a suitable amount of the total content of the overcharge additives existing in the nonaqueous electrolyte used in fabricating the batteries is set at 4 mass % or more and 5 mass % or less based on 100 mass % of the nonaqueous electrolyte, the securement of the durability (the capacity retention rate) and the securement of the overcharge-time gas generation amount can be made compatible at a high level.

Next, a suitable amount of biphenyl existing in the nonaqueous electrolyte used in fabricating the batteries will be reviewed while comparing the batteries of examples 1, 5, 7 and 11 with one another. The batteries of examples 1, 5, 7 and 11 differ from one another in the content of biphenyl existing in the nonaqueous electrolyte used in fabricating the respective batteries. In the batteries of examples 1, 5, 7 and 11, the total content of the overcharge additives existing in the nonaqueous electrolyte used in fabricating the battery (here, the total sums of the content of biphenyl and the content of CHB) are equal to one another, namely 5 mass % based on 100 mass % of the nonaqueous electrolyte. In the battery of example 5 which does not contain biphenyl, the capacity retention rate was a small value of 90% or less. All the overcharge-time battery internal pressure increments (relative values) under the three conditions (room temperature, high temperature and after endurance) were low, namely less than 1.0 times. Presumably, this is because, due to the non-addition of biphenyl to the nonaqueous electrolyte, no conductive film was formed in the broken portions of the negative electrode active material and the conductive paths were disconnected. On the other hand, in the batteries of examples 7 and 11 in which the biphenyl concentration is relatively high, namely 2 mass % or more based on 100 mass % of the nonaqueous electrolyte, the capacity retention rate was a large value of 92% or more. However, one or all of the overcharge-time battery internal pressure increments (relative values) under the three conditions (room temperature, high temperature and after endurance) were reduced to less than 1.0 times. Presumably, this is because, due to the increased content of biphenyl, the overcharge-time gas generation efficiency (especially the overcharge-time gas generation efficiency under the high temperature condition) was decreased. From the foregoing, it can be noted that, if a suitable amount of biphenyl contained in the nonaqueous electrolyte (namely the nonaqueous electrolyte not subjected to the charging/discharging process) used in fabricating the batteries is set at 0.5% or more and 1% or less, the securement of the durability (the capacity retention rate) and the securement of the overcharge-time gas generation amount can be made compatible at a high level.

Next, a suitable film amount (μmol/m²) of the DFP film per unit surface area (1 m²) of the positive electrode active material will be reviewed while comparing the batteries of examples 1, 2 and 8 with one another. The batteries of examples 1, 2 and 8 differed from one another in the film amount (μmol/m²) of the DFP film per unit surface area (1 m²) of the positive electrode active material. In the battery of example 8 in which the film amount of the DFP film is relatively low, namely 1.2 μmol/m² or less, the capacity retention rate was a small value of 90% or less. All the overcharge-time battery internal pressure increments (relative values) under the three conditions (room temperature, high temperature and after endurance) were reduced to less than 1.0 times. Presumably, this is because the film amount of the DFP film per unit surface area (1 m²) of the positive electrode active material was small and because the DFP film could not sufficiently demonstrate the effect of inhibiting the formation of the LiF film. It is thought that, as a result, the formation of the conductive film became insufficient and the conductive paths could not be sufficiently secured. From the foregoing, it can be noted that, if a suitable amount of the film amount (μmol/m²) of the DFP film per unit surface area (1 m²) of the positive electrode active material is set at 1.5 μmol/m² or more and 4.0 μmol/m² or less, the securement of the durability (the capacity retention rate) and the securement of the overcharge-time gas generation amount can be made compatible at a high level.

Next, a suitable value of the lattice volume change rate of the positive electrode active material available when a lattice volume of a crystallite of the positive electrode active material at an SOC of 80% is compared with a lattice volume of a crystallite of the positive electrode active material at an SOC of 110% will be reviewed while comparing the batteries of examples 1 and 10. The batteries of examples 1 and 10 differed from each other in the lattice volume change rate (%) of the positive electrode active material. In the battery of example 10 in which the lattice volume change rate (%) of the positive electrode active material is relatively large, namely 4%, the capacity retention rate was a small value of 90% or less. All the overcharge-time battery internal pressure increments (relative values) under the three conditions (room temperature, high temperature and after endurance) were low, namely less than 1.0 times. Presumably, this is because, due to the large lattice volume change rate (%) of the positive electrode active material, a larger number of broken portions could be formed on the surface of the positive electrode active material and because, due to the insufficient formation of the conductive film in the broken portions, the conductive paths could not be sufficiently secured. From the foregoing, it can be noted that, if a suitable value of the change rate (%) of a lattice volume of a crystallite of the positive electrode active material at an SOC of 80% and a lattice volume of a crystallite of the positive electrode active material at an SOC of 110% is set larger than 0% and equal to or smaller than 3%, the securement of the durability (the capacity retention rate) and the securement of the overcharge-time gas generation amount can be made compatible at a high level.

As described above, according to the technology disclosed herein, it is possible to provide a lithium-ion secondary battery in which the securement of the battery characteristics (the cycle characteristics and the durability) during the time of normal use and the securement of the gas generation amount during the overcharge time can be made compatible at a high level.

While the invention has been described in detail, the embodiments and examples described above are nothing more than illustrations. Different modifications and changes of the aforementioned specific examples are included in the invention disclosed herein.

1. A lithium-ion secondary battery manufacturing method for manufacturing a lithium-ion secondary battery provided with an electrode body and a nonaqueous electrolyte, comprising:
a battery assembly fabricating step in which a battery assembly is fabricated by providing inside a battery case a positive electrode having a positive electrode active material, a negative electrode having a negative electrode active material, and a nonaqueous electrolyte containing an overcharge additive and difluorophosphate;
a first charging step in which a battery is fabricated by performing a first charging process with respect to the battery assembly; and
a conditioning step in which the battery subjected to the first charging step is conditioned,
wherein in the conditioning step, discharging to a predetermined lowest SOC and charging to a predetermined highest SOC are performed at least once,
the predetermined lowest SOC and the predetermined highest SOC are values enabling a volume change rate of a lattice volume of a crystallite of the positive electrode active material when the lattice volume of the crystallite of the positive electrode active material at the lowest SOC is compared with the lattice volume of the crystallite of the positive electrode active material at the highest SOC to become larger than 0% and equal to or smaller than 3%, and the highest SOC is set as an SOC value enabling a potential at which a conductive film derived from the overcharge additive can be formed.

2. The method according to claim 1, wherein biphenyl and one or more kinds of aromatic compound other than biphenyl is used as the overcharge additive, and
a compound having an oxidation potential higher than an oxidation potential of the biphenyl based on a standard potential of a lithium electrode is used as the aromatic compound.

3. The method according to claim 2, wherein the nonaqueous electrolyte comprises a nonaqueous electrolyte in which a total content of the overcharge additive based on 100 mass % of the nonaqueous electrolyte is 4 mass % or more and 5 mass % or less and in which a content of the biphenyl based on 100 mass % of the nonaqueous electrolyte is 0.5 mass % or more and 1.0 mass % or less.

4. The method according to claim 1, wherein, by performing the first charging step and the conditioning step, a film derived from the difluorophosphate is formed on a surface of the positive electrode active material such that a film amount per 1 m² of the positive electrode active material on a molar basis of the difluorophosphate becomes 1.5 μmol or more and 4.0 μmol or less.

5. The method according to claim 1, wherein the positive electrode active material comprises a positive electrode active material in which the volume change rate of the lattice volume of the crystallite when the lattice volume of the crystallite at an SOC of 80% is compared with the lattice volume of the crystallite at an SOC of 110% is larger than 0% and equal to or smaller than 3%.

6. A lithium-ion secondary battery manufactured by the lithium-ion secondary battery manufacturing method according to claim 1,
wherein the positive electrode active material includes broken portions, and
a film derived from difluorophosphate and the conductive film derived from the overcharge additive are formed in the broken portions of the positive electrode active material.
